(19) United States
(12) Patent Application Publication
(10) Pub. No.: US 2010/0270388 A1
(43) Pub. Date: Oct. 28, 2010

(54) ATMOSPHERE SIMULATION METHOD AND ELECTRONIC APPARATUS HAVING A FUNCTION OF SIMULATING AN ATMOSPHERE

(75) Inventors: Chen-Chen Liu, Taipei (TW); Jiun-Ting Luo, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INVENTEC APPLIANCES CORP., Taipei (TW)

(21) Appl. No.: 12/765,978

(22) Filed: Apr. 23, 2010

(30) Foreign Application Priority Data
Apr. 23, 2009 (TW) 098113478

(51) Int. Cl. B05B 17/00

(52) U.S. Cl. 239/1; 239/289

(57) ABSTRACT

The invention discloses an atmosphere simulation method and an electronic apparatus having a function of simulating atmosphere. The atmosphere simulation method is applicable to an electronic apparatus capable of using multimedia to produce an atmosphere, the electronic apparatus comprising an odor module, the atmosphere simulation method comprising the following steps of (a) determining information of the atmosphere, and generating a signal for releasing an odor correspondingly, (b) transmitting the odor releasing signal to the odor module, and (c) causing the odor module to release the odor for simulating an atmosphere according to the odor releasing signal.

### CROSS-REFERENCE TO RELATED APPLICATION

This application is a utility application that claims priority to Taiwan Patent Application entitled, “Situation Simulation Method and Electronic Apparatus with Situation Simulation Function”, having Serial Number 098113478, filed Apr. 23, 2009, which is entirely incorporated herein by reference.

### BACKGROUND OF THE INVENTION

1. Field of the Invention

The invention is related to an atmosphere simulation method and an electronic apparatus having a function of simulating an atmosphere, and more particularly, to an atmosphere simulation method for releasing odor and an electronic apparatus having a function of simulating an atmosphere.

2. Description of the Prior Art

Nowadays, electronic communication technology is developing rapidly. The different media, such as internet, radio broadcast and cable TV, are very popular for broadcasting. With the development of the third generation mobile communication technology, many handheld communication devices allow people to transmit pictures, sounds, and even video to each other. By all these methods of transmitting information, communications between people become more and more comprehensive. The communication between users is no longer limited to a form of speech, but the users are capable of observing the facial and body expressions reciprocally to fulfill users' senses of sight and hearing as if the users are on the spot.

The electronic apparatus for generating different types of atmosphere have been generally performed in the field of medical science, communication, gaming experience, business conferences, and advertisement marketing. For example, virtual reality hardware and software can be applied to provide specific visual experience via a computer screen, a special display equipment or a 3D display device, and provide specific audio experience via HI-FI or headphones. Some simulation devices can also comprise other concept processes, for example, some of the advanced systems contain the physical sensation messages, also known as a force feedback system.

To provide more realistic sensation experience, a comprehensive atmosphere simulation should further include an odor corresponding to the atmospheres for fulfilling the requirement of the smelling sense or the fifth sense of the user. However, the atmosphere simulation devices or methods in prior art are not capable of providing an odor suitably by a simple and effective design.

The invention discloses an atmosphere simulation method and an electronic apparatus having a function of simulating an atmosphere to solve the above-mentioned problem.

### SUMMARY OF THE INVENTION

An objective of the present invention is to provide an atmosphere simulation method, the atmosphere simulation method performed on an electronic apparatus comprising an odor module. The atmosphere simulation method comprises the following steps of: (a) determining information of the atmosphere, and generating a signal for releasing an odor correspondingly; (b) transmitting the odor releasing signal to the odor module; and (c) causing the odor module to release the odor for simulating an atmosphere, according to the odor releasing signal.

To achieve a previous objective, step (c) further comprises the following steps of: (c1) determining if use of the multimedia is ended; (c2) if it's determined that use of the multimedia is ended, turning off the odor module; (c3) if it's determined that use of the multimedia is not ended, returning to the step (a) after a predetermined period.

For a better result, said method further comprises the following steps of: storing pieces of the atmosphere information and odor parameters, wherein each of the pieces of the atmosphere information corresponds to one of the odor parameters, and the odor releasing signal corresponds to one of the odor parameters.

Wherein the odor module comprises at least one odor generating unit used to generate at least one basic odor, and the odor derives from the at least one basic odor, wherein the odor module comprises at least one odor generating unit used to generate at least one basic odor, which is a constituent part of the odor.

In practice, the multimedia pertains to an audio file, and the atmosphere information is about volume, rhythm, a producer, or an audio style of audio of the audio file.

While the multimedia pertains to an audio-visual file, and the atmosphere information is about a cinematic scene, a scenario, a producer, or a cinematic style of a motion picture of the audio-visual file.

While the multimedia pertains to an audio-visual stream received from a transmitting end, and the atmosphere information is about a background, a geographical location, or an identification of the transmitting end.

While the objective of the present invention will no doubt become obvious to those of ordinary skill in the art after reading the following detailed description of the preferred embodiment, which is illustrated in the following figures.

Another objective of the present invention is to provide an electronic apparatus having a function of simulating an atmosphere and comprising a multimedia module, an odor module and a processing module. The multimedia module is for using multimedia to produce an atmosphere information. The processing module is electrically connected with the multimedia module and the odor module. The processing module is used to determine information of the atmosphere and cause a signal for releasing an odor correspondingly, for the odor module, in order to cause the odor module to release the odor, according to the odor releasing signal, for simulating the atmosphere.

In practice, the electronic apparatus further comprises a storage unit. The storage unit is electrically connected to the processing module for storing pieces of the atmosphere information and odor parameters. Each of the pieces of the atmosphere information corresponds to one of the odor parameters. The odor releasing signal corresponds to one of the odor parameters. The odor module comprises at least one odor generating unit to generate at least one basic odor, and the odor derives from the at least one basic odor. Furthermore, the odor module comprises at least one odor generating unit used to generate at least one basic odor, which is a constituent part of the odor.

In practice, the multimedia pertains to an audio file, and the atmosphere information is about volume, rhythm, a producer, or an audio style of audio of the audio file.

While the multimedia pertains to an audio-visual file, and the atmosphere information is about a cinematic scene, a scenario, a producer, or a cinematic style of a motion picture of the audio-visual file.

In practice, the electronic apparatus further comprises a communication module, wherein the multimedia pertains to an audio-visual stream sent from a transmitting end and received by the communication module, and the atmosphere information is about a background, a geographical location, or an identification of the transmitting end.

In comparison with the invention of the prior art, the atmosphere simulation method of the present invention is capable of determining the multi-media in play to generate or release a corresponding odor in accordance with the atmosphere information from the multimedia, so as to achieve the objective of diversify of atmosphere simulation, small size and low electricity consumption.

The objectives of the present invention will no doubt become obvious to those of ordinary skill in the art after reading the following detailed description of the preferred embodiment, which is illustrated in following figures.

### BRIEF DESCRIPTION OF THE APPENDED DRAWINGS

The teachings of the present invention can be readily understood by considering the following detailed description in conjunction with the accompanying drawings, in which:

FIG. 1 is a function block diagram illustrating an electronic apparatus having a function of simulating an atmosphere according to a first preferred embodiment of the invention.

FIG. 2 is a function block diagram illustrating an electronic apparatus having a function of simulating an atmosphere according to a second preferred embodiment of the invention.

FIG. 3 is a flow diagram illustrating an atmosphere simulation method according to an embodiment of the invention.

### DETAILED DESCRIPTION OF THE INVENTION

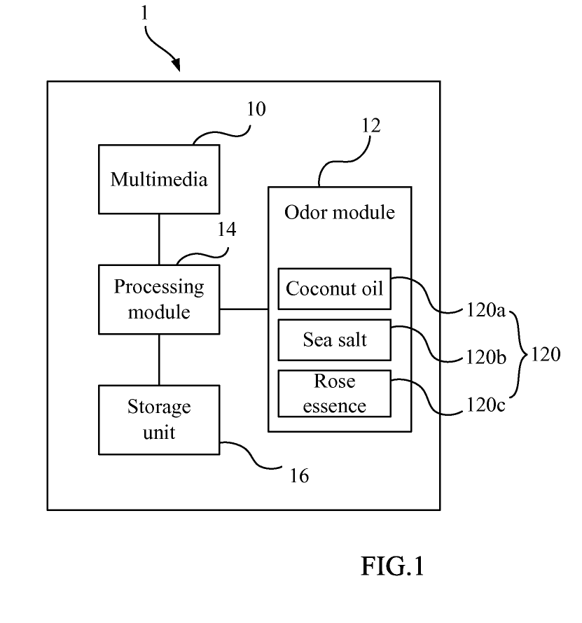

Please refer to FIG. 1. FIG. 1 is a function block diagram illustrating an electronic apparatus 1 having a function of simulating an atmosphere according to a first preferred embodiment of the invention.

The electronic apparatus 1 can be a multimedia carrier capable of playing or displaying multimedia. For example, the multimedia carrier is a personal computer, a personal digital assistance, a PDA, or a portable communication apparatus. More practically, the electronic apparatus 1 can be performed on a smart phone to enable an extra function of simulating an atmosphere.

In practice, the said function of simulating an atmosphere is performed on a smart phone which supports video call function. As shown in FIG. 1, the electronic apparatus 1 comprises a multimedia 10, an odor module 12, a processing module 14 and a storage unit 16. The multimedia 10, the odor module 12 and the storage unit 16 are electrically connected with the processing module 14.

In this embodiment, the multimedia pertains to an audio-visual file. The atmosphere information is about a cinematic scene, a scenario, a producer, or a cinematic style of a motion picture of the audio-visual file. The atmosphere information is produced in accordance with the contents of the multimedia 10.

The odor module 12 can be constituted by a conducting portion with capillary structure and a corresponding control unit. In an embodiment, the conducting portion with capillary structure can be formed by capillary-type metal or any other conducting materials with capillary structure.

The conducting portion with capillary structure can be a container or housing for accommodating the essence or volatile liquid. In practice, the controlling unit is capable of replying the request of the controlling signal (odor releasing signal) to heat up the volatile liquid in conducting portion.

For example, when a voltage is applied on the conducting portion, the conducting portion is heated up for controlling the releasing rate of the odor. The volatile liquid is accommodated in the capillary structure of the conducting portion. Furthermore, the essence and the volatile liquid utilized for generating odor can be refilled and be stored in a conducting portion with capillary structure or an accommodating slot connected therewith.

The processing module 14 determines an atmosphere-information of the multimedia in play and generates an odor releasing signal in accordance with the atmosphere information correspondingly. For example, while the cinematic scene of the multimedia is about ocean, the processing module determines the atmosphere information and generates an odor releasing signal corresponds to the atmosphere of ocean.

The processing module 14 transmits the odor releasing signals to the odor module 12 for controlling the odor module 12 to release the odor in accordance with the odor releasing signals. In this embodiment, the odor module 12 comprises three odor generating units 120a, 120b, and 120c. Each of the odor generating unit 120 may comprise a conducting portion with capillary structure so that the odor generating unit 120 can accommodate various volatile liquids respectively.

Accordingly, three basic odors can be released by odor module 12. In this embodiment, the odor derives from at least one of the basic odors. For example, by turning on the odor generating unit 120a and odor generating unit 120b simultaneously, 30% basis odor of coconut oil and 70% basis odor of sea salt are released and mixed together to form an odor corresponds to the atmosphere of ocean.

In this embodiment, there are, but not limited to, three odor generating units 120 installed in the odor module 12. In practice, at least one of the odor modules 12 can be installed to the odor module 12 in accordance with the space, cost and any other considerations of design. As more elements of the odor generating unit 120 are installed, more odors can be released and more fitting.

In a previous embodiment, the odor is formed by mixing various basic odors together in different ratio. However, the present invention is not limited to the previous embodiment. In another embodiment, the odor derives from one basic odor. In another word, the released odor can be composed of a single basic odor. For example, by turning on the odor generating unit 120c, the rose essence is heated up to release the basic odor, so as to form an odor corresponding to the atmosphere of garden. By utilizing the various elements of the odor generating unit 120 independently, the objective of simulating various atmospheres can be achieved.

In this embodiment, the storage unit 16 is utilized to store a plurality of atmosphere information and odor parameters. Each of the pieces of the atmosphere information corresponds to one of the odor parameters. And the odor releasing signal corresponds to one of the odor parameters. The storage unit 16 is utilized to define the relative relation between the atmosphere information and odor releasing signal by coordinating with the processing module 14.

The odor parameter can be utilized to define in detail the type and the ratio of the basic odors comprising the odor according to various pieces of atmosphere information.

For example, the odor corresponding to the atmosphere of ocean is composed of two different odors in a ratio of 30% coconut oil and 70% sea salt.

In another embodiment, the odor parameter can also be utilized to define the viscosity of the odor, for example, by tuning the releasing rate of the odor parameter, the concentration of the odor of sweet-scented osmanthus can be simulated.

In another embodiment, the odor module 12 releases the odor to the air by dissipating the odor.

In another embodiment, multimedia pertains to an audio file, and the atmosphere information is about volume, rhythm, a producer, or an audio style of audio of the audio file.

For example, when the audio file is about rock and roll style music in fast rhythm, the electronic apparatus 1 releases an excitatory odor in accordance with the atmosphere information. In another embodiment, when the audio file is about brisk country music, the electronic apparatus 1 releases the odor of herbage.

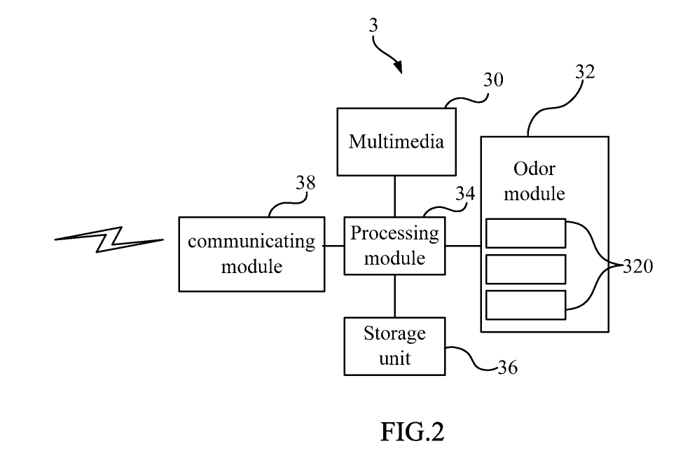

Please refer to FIG. 2. FIG. 2 is a function block diagram illustrating an electronic apparatus 1 having a function of simulating an atmosphere according to a second preferred embodiment of the invention.

In this embodiment, the odor module 32 comprises at least one odor generating unit 320. Each of the odor generating units 320 may comprise a conducting portion with capillary structure so that the odor generating units 320 can accommodate various volatile liquids.

In comparison with the first preferred embodiment, the electronic apparatus 3 further comprises a communicating module 38. The communicating module 38 is electrically connected with the processing module 34. The storage unit 36 can be connected with the processing module 34. The other elements which are not described are approximately the same as those in the first preferred embodiment, so discussion of the same details will be herein omitted.

Meanwhile, the electronic apparatus 3 has a function of communication. The electronic apparatus 3 can be, but not limited to, a computer connected to the internet or a mobile phone having wireless communication function. In this embodiment, the electronic apparatus 3 is a mobile phone applying the third generation mobile communication technology with a video call function.

If the user communicates with his/her relative via video call, the user is able to receive the message of multimedia 30 via the communicating module 38 of the electronic apparatus 3. The multimedia 30 pertains to an audio-visual stream. The electronic apparatus 3 is capable of reading and playing the video and audio-visual stream. Since the technology of audio-visual streaming is known by the one in art, discussion of unnecessary details will be hereby omitted.

In this embodiment, the atmosphere information of multimedia 30 is about a background, a geographical location, or an identification of the transmitting end.

For example, when the user of the transmitting end is having a luxuriant dinner, the electronic apparatus 3 is capable of determining and releasing the odor of the food in accordance with the atmosphere information of the streaming media to let the user feels like being on spot of the dinner via the video, sound and the odor to present the atmosphere of the transmitting end.

Accordingly, the electronic apparatus 3 of present invention has the function of simulating the atmosphere in accordance with the atmosphere of video, music and real time communication by generating the odor releasing signal correspondingly.

The odor releasing signal corresponds to at least one of the odor parameters for driving the odor module to release at least one basis odor and to form the corresponding odor in accordance with various atmosphere requirements.

Furthermore, the odor module 32 can comprise capillary-type metal and controlling unit. The capillary-type metal can be utilized as a tunnel, a space for accommodating and a device for heating. For meeting the requirements of the handheld electronic apparatus 3, the objectives of having smaller size, lighter weight and lower electricity consumption can be achieved by integrating the capillary-type metal and controlling unit to a size of a small chip by the manufacturing process.

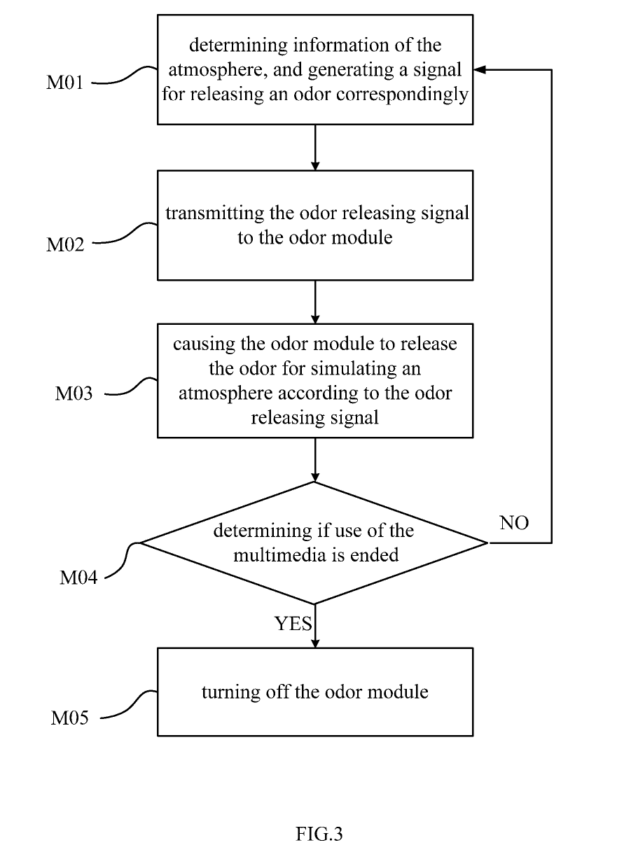

FIG. 3 is a flow diagram illustrating an atmosphere simulation method according to an embodiment of the invention. In this embodiment, an atmosphere simulation method is applicable to an electronic apparatus 1 capable of using multimedia to produce an atmosphere. The electronic apparatus 1 comprises an odor module.

As shown in FIG. 3, the atmosphere simulation method comprises the following steps. First, step M01 is to determine the information of the atmosphere and generate a signal for releasing an odor correspondingly. In this embodiment, the multimedia pertains to an audio-visual file, and the atmosphere information is about a cinematic scene, a scenario, a producer, or a cinematic style of a motion picture of the audio-visual file.

Then, step M02 is to transmit the odor releasing signal to the odor module. In this embodiment, odor module comprises at least one odor generating unit. Each of the odor generating units 120 may comprise a conducting portion with capillary structure so that the odor generating units 120 can accommodate various volatile liquids, or each of the odor generating units 120 can be utilized to release one basic odor respectively.

Then, STEP M03 is to drive the odor module to release the odor for simulating an atmosphere according to the odor releasing signal. In this embodiment, at least one odor generating unit is used to generate at least one basic odor which is a constituent part of the odor. For example, by releasing two basic odors simultaneously to synthesize both of the basic odors in the air to form an odor corresponds to the atmosphere of forest. The said basic odor is composed of 60% camphor tree essential oil and 40% green tea essential oil respectively.

The atmosphere simulation method further comprises another step (not shown), the step is to store the atmosphere information and a plurality of odor parameters. Each of the atmosphere information corresponds to one of the plurality of the odor parameters, and the odor releasing signal corresponds to one of the plurality of odor parameters. The odor parameters can be utilized to define the relative relation between atmosphere and basic odor to let the effect of the odor become more diversified and precise.

Then step M04 is to determine if use of the multimedia is ended; and if it's determined that use of the multimedia is ended, then run step M05 to turn off the odor module.

In another word, if it's determined that use of the multimedia is not ended, returning to step M01 after a predetermined period, and determining the atmosphere information of the multimedia again to update the atmosphere signal odor instantly or to reinforce the released odor to form a real time atmosphere simulation.

In another embodiment, multimedia can pertains to an audio file, the atmosphere information is about volume, rhythm, a producer, or an audio style of audio of the audio. In another embodiment, the multimedia pertains to an audio-visual stream received from a transmitting end, and the atmosphere information is about a background, a geographical location, or an identification of the transmitting end.

In comparison with prior art, the atmosphere simulation method and electronic apparatus having a function of simulating an atmosphere are capable of analyzing a state of multimedia and releasing the corresponding odors in accordance with the atmosphere information instantly to achieve the objective of simulating various atmospheres, low electricity consumption and capable of performing on the handheld electronic apparatus 1.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An atmosphere simulation method applicable to an electronic apparatus capable of using multimedia to produce an atmosphere, the electronic apparatus comprising an odor module, the atmosphere simulation method comprising the following steps of:
(a) determining information of the atmosphere, and generating a signal for releasing an odor correspondingly;
(b) transmitting the odor releasing signal to the odor module; and
(c) causing the odor module to release the odor for simulating an atmosphere, according to the odor releasing signal.

2. The method of claim 1, further comprising:
(c1) determining if use of the multimedia is ended; and
(c2) if it's determined that use of the multimedia is ended, turning off the odor module.

3. The method of claim 2, further comprising:
(c3) if it's determined that use of the multimedia is not ended, returning to the step (a) after a predetermined period.

4. The method of claim 1, further comprising:
(d) storing pieces of the atmosphere information and odor parameters, wherein each of the pieces of the atmosphere information corresponds to one of the odor parameters, and the odor releasing signal corresponds to one of the odor parameters.

5. The method of claim 1, wherein the odor module comprises at least one odor generating unit used to generate at least one basic odor, and the odor derives from the at least one basic odor.

6. The method of claim 1, wherein the odor module comprises at least one odor generating unit used to generate at least one basic odor, which is a constituent part of the odor.

7. The method of claim 1, wherein the multimedia pertains to an audio file, and the atmosphere information is about volume, rhythm, a producer, or an audio style of audio of the audio file.

8. The method of claim 1, wherein the multimedia pertains to an audio-visual file, and the atmosphere information is about a cinematic scene, a scenario, a producer, or a cinematic style of a motion picture of the audio-visual file.

9. The method of claim 1, wherein the multimedia pertains to an audio-visual stream received from a transmitting end, and the atmosphere information is about a background, a geographical location, or an identification of the transmitting end.

10. An electronic apparatus having a function of simulating an atmosphere, comprising:
a multimedia module for using multimedia to produce an atmosphere information;
an odor module; and
a processing module electrically connected with the multimedia module and the odor module, the processing module being used to determine information of the atmosphere and cause a signal for releasing an odor correspondingly, for the odor module, in order to cause the odor module to release the odor, according to the odor releasing signal, for simulating the atmosphere.

11. The electronic apparatus of claim 10, further comprising:
a storage unit, electrically connected to the processing module, for storing pieces of the atmosphere information and odor parameters, wherein each of the pieces of the atmosphere information corresponds to one of the odor parameters, and the odor releasing signal corresponds to one of the odor parameters.

12. The electronic apparatus of claim 10, wherein the odor module comprises at least one odor generating unit used to generate at least one basic odor, and the odor derives from the at least one basic odor.
The electronic apparatus of claim 10, wherein the odor module comprises at least one odor generating unit used to generate at least one basic odor, which is a constituent part of the odor.
The electronic apparatus of claim 10, wherein the multimedia pertains to an audio file, and the atmosphere information is about volume, rhythm, a producer, or an audio style of audio of the audio file.
The electronic apparatus of claim 10, wherein the multimedia pertains to an audio-visual file, and the atmosphere information is about a cinematic scene, a scenario, a producer, or a cinematic style of a motion picture of the audio-visual file.
The electronic apparatus of claim 10 further comprising a communication module, wherein the multimedia pertains to an audio-visual stream sent from a transmitting end and received by the communication module, and the atmosphere information is about a background, a geographical location, or an identification of the transmitting end.
